(19) United States
(12) Patent Application Publication
(10) Pub. No.: US 2018/0148313 A1
(43) Pub. Date: May 31, 2018

(54) BASE FABRIC MATERIAL HAVING PAD MEMBER WITH CORE AND MANUFACTURING METHOD THEREOF

(71) Applicant: YAMAYA SANGYO CO., LTD., Kahoku-shi (JP)

(72) Inventor: Yoshitaka KOMURA, Kahoku-shi, Ishikawa (JP)

(21) Appl. No.: 15/578,070

(22) PCT Filed: Dec. 22, 2016
(86) PCT No.: PCT/JP2016/088526

§ 371 Date: Nov. 29, 2017

(30) Foreign Application Priority Data
Dec. 25, 2015 (JP) 2015-254656

(51) Int. Cl. B68G 7/05; A41B 11/00; A41H 43/04; A63B 71/12; A41D 13/08; A41D 13/015; A47G 9/10

(52) U.S. Cl. CPC B68G 7/05; A41B 11/00; A41H 43/04; A63B 71/1225; A41D 2600/10; A63B 71/12; A41D 13/015; A47G 9/10; A63B 2071/125; A41D 13/08

(57) ABSTRACT

To provide a base fabric material having a pad member with a core and a manufacturing method thereof, the pad member with the core being capable of quickly and strongly joining the pad member, on which the core such as a cushion material is disposed, with beautiful finish in a state where the core is made to sufficiently project outward. The pad member having the core is joined to a one side surface of the base fabric material via an adhesive film, with its substantially entire area in thickness projecting, by performing thermocompression bonding by using a concave mold K, a convex mold HK, or the like having a hole or a groove made to match a shape or a thickness of the core. The adhesive film is made to have a mesh-like shape, or an adhesion preventing cloth is disposed and so on so as to ensure ventilation property.

### TECHNICAL FIELD

The present invention relates to a base fabric material having a pad member with a core used in sandwiching a cushion material or a thermal insulating material with a pad member to attach to a supporter, a sock, a pillow or the like, and a manufacturing method thereof.

### BACKGROUND ART

When a cushion material or the like composed of an elastic foam material is attached to a cylindrical portion having elasticity of a supporter or the like, a method for superposing a pad member on a cushion material or the like and sewing a circumference of the pad member to the supporter or the like is used.

Since a supporter or the like has a cylindrical shape and has elasticity, it is prone to deform abnormally when a sewing machine is used so that the cushion material or the like is attached in a distortion state, therefore the sewing operation is difficult. Specifically, the difficulty is remarkable in a supporter for elbow or ankle and a pillow that are thin. Consequently, the operation is low in efficiency and a worker needs a high degree of skill.

In contrast, the applicant has already proposed a new method for facilitating the sewing operation to increase efficiency (Patent Literature 1). In the method, a pad member is tacked to a base fabric material using a low melting point yarn that functions as an adhesive agent or a heat adhesive film before the above sewing process, which makes the sewing operation easy, makes it possible to efficiently perform the sewing operation without skill, and yields beautiful finish.

However, in the joining method of above Patent Literature 1, the sewing process is performed after the tacking process, not only making the process long but also resulting in concern about increasing in cost due to a member for the tacking process, and the like.

To solve the above problems of the above proposition (Patent Literature 1), the applicant has further proposed a manufacturing method of a supporter with a protective member using a heat adhesive film (Patent Literature 2). In the manufacturing method, a protective member is adhered by heat to a supporter by a heat adhesive film, or a protective member is adhered by heat by a cover material and a heat adhesive film. Since the protective member is adhered to the supporter in a good state, the need for the sewing operation that used to be essential is eliminated, the complication of process and concern about increasing in cost that are problems in Patent Literature 1 are resolved.

### CITATION LIST

### Patent Literature

PTL1: JP-A-3-279402

PTL2: JP-A-6-134071

### SUMMARY OF INVENTION

### Technical Problem

However, for example, in a knee supporter for volleyball, a pillow constituting an uneven surface cloth, and the like, its cushion material (core) is required to project on a surface side.

The above conventional manufacturing methods of the publications fail to attach the cushion material with sufficient projection. Specifically, in a supporter cloth composed of an elastic material, it is difficult to join a core such as a cushion material to project outward while keeping its elasticity and cylindrical shape.

Furthermore, when thermal fusion bonding is performed to a supporter body (cylindrical supporter) on which a core such as a cushion material such as a knee pad, an elbow pad, and a waist pad is disposed via an adhesive agent by the manufacturing methods of the above conventional publications, there are problems in that thermal fusion bonding is mistakenly performed to the cushion material, sufficient ventilation property fails to be ensured depending on a melted section, and moreover, quick finish with strong joining cannot to be achieved , and so on.

Therefore, an object of the invention is to provide a base fabric material having a pad member with a core capable of quickly and strongly joining the pad member on which the core such as a cushion material is disposed with beautiful finish in a state where the core is made to sufficiently project outward, and a manufacturing method thereof.

### Solution to Problem

A base fabric material having a pad member with a core includes: a base fabric material having elasticity; a core disposed to project from a one side surface of the base fabric material in its entire area by being adhered to the base fabric material by using a mold having a convex shape, a concave shape, or the like; a pad member disposed to cover the core; and an adhesive layer for joining them.

Furthermore, a base fabric material having a pad member with a core of the invention includes a base fabric material having elasticity and having an annular cross-section; a core disposed to project from an outer face of the base fabric material in its entire area by being adhered to the base fabric material by using a mold having a convex shape, a concave shape, or the like from an inner face of the base fabric material; a pad member disposed on the inner face of the base fabric material to cover the core; and an adhesive layer for joining them.

Herein, “inner face” is the surface of the base fabric material having an annular shape in the cross-section to become inside when the base fabric material having the pad member with the core is used, and denotes the surface to be in contact with a body surface of a user.

Furthermore, “outer face” is the surface of the base fabric material having an annular shape in the cross-section to appear on the outside when the base fabric material having the pad member with the core is used, and denotes the surface to be not in contact with a body surface of a user.

Herein, “adhesive layer” denotes an adhesive member formed on a member for joining, and shall denote an adhesive film, an adhesive agent, or the like.

According to the invention, applying the invention to a knee pad supporter, an elbow pad supporter, or a waist pad supporter not only yields strong adhesion but also makes surface finish well-looking, and makes the pad member having the core project in one side surface of the base fabric material in the substantially entire area of its thickness, improving impact absorption force to knee, elbow, or waist.

In the invention, the base fabric material having a pad member with a core further includes an adhesion preventing cloth disposed at a non-adhered section of the adhesive layer, and ventilation property is ensured at a position at which the adhesion preventing cloth is disposed.

According to the invention, a section to which an adhesive agent is applied and a section to which no adhesive agent is applied is separated so as to prevent a situation such as adhesion of the adhesive agent to the cushion material, or to explicitly distinguish between a portion to ensure ventilation property and a portion to ensure no ventilation property, for example, making possible to provide a base fabric material having a pad member with a core in consideration of ventilation property or the like.

In the invention, the pad member is a pile woven fabric, a spinning cloth, or a textile cloth in which loops for making an adhesive agent of the adhesive layer be infiltrated and cured therein is formed on its side of the adhesive film.

According to the invention, strong adhesion between the pad member and the base fabric material is obtained so that peeling off is hardly occurred.

In the invention, the base fabric material is a supporter or a waist pad supporter having cylindrical shape and elasticity, and the core is a cushion material for a knee pad, an elbow pad or a waist pad.

According to the invention, since strong adhesion in the supporter in which the base fabric material has the cylindrical shape and elasticity, peeling off is hardly occurred even by strenuous exercise, and the pad member having the core projects in the one side surface of the base fabric material in its substantially entire area of thickness. Therefore, the ability of absorbing the impact on knee, elbow, or waist is improved.

In the invention, the adhesive layer is disposed at a corner of the core, and a fold is formed around the core in the base fabric material having the pad member with the core. For example, the adhesive film is disposed to be located from an inside corner to an outer circumference side of a concave mold, and the adhesive film is melted along an outer circumference of the pad member to adhere the pad member to the base fabric material.

According to the invention, it is allowed that a fold is formed in the pad member having the core, and the adhesive film is disposed to be located from the inside corner to the outer circumference side of the concave mold, it is thus possible to prevent shapeless of the pad member having the core.

In the invention, the adhesive layer is an adhesive film formed to have a size larger than an adhesive area of the core and having a substantially same size as the pad member, and a portion between the one side entire surface of the core and the pad member and a portion between the base fabric material located at a one side outer circumference of the core and the pad member are strongly adhered by the adhesive film.

According to the invention, when the pad member equipped with the adhesive film larger than the adhesive area of the core is adhered to the adhesive surface of the core and the base fabric material at an outer circumference of the adhesive surface of the core, strong adhesion is achieved between the adhesive surface of the core and the pad member because the adhesive layer exists in the entire surface, and since the size of the pad member is formed larger than the adhesive surface of the core, the base fabric material located at the outer circumference of the adhesive surface and the pad member are simultaneously and strongly adhered. Since not only the core but also the entire circumference of the adhesive surface of the core is strongly adhered to the pad member, the core is fixed to the base fabric material more strongly without causing positional displacement of the core, and it becomes possible to keep a state in which the core sufficiently projects on the outer surface for a long period, it is thus possible to provide the pad member with the core that have a high durability and does not cause shapeless even when being used repeatedly.

Furthermore, a manufacturing method of a base fabric material having a pad member with a core of the invention includes: providing a base fabric material having elasticity, a core such as a cushion material, a pad member disposed to cover the core, and an adhesive layer for joining them, and adhering them by using a mold having a concave shape, a convex shape, or the like having a hole or a groove made to match a shape or a thickness of the core so as to join the pad member having the core to a one side surface of the base fabric material with its substantially entire area of thickness projecting.

Furthermore, the manufacturing method of the base fabric material having the pad member with the core includes inserting a mold having a hole or a groove made to match a shape and a thickness of a core inside a base fabric material having elasticity and having an annular cross-section whose front and back are inverted, disposing the core and a pad member to which an adhesive layer is temporally adhered on an inner face of the base fabric material, melting the adhesive layer by heating by a hot plate from a side of the pad member, and making the core project inside the hole or the groove of the mold so as to forming adhesion between the base fabric material and the pad member.

According to the invention, when the base fabric material, the core, and the pad member are adhered by using the mold having a convex shape, a concave shape, or the like via an adhesive layer, both of the base fabric material and the pad member project along the shape of the concave mold. Therefore, it possible to sufficiently project the thickness of the core on one surface side, and to achieve quick and strong adhesion.

Herein “adhesion” shall include various adhesion methods such as thermocompression bonding, adhesion by ultraviolet, adhesion by mixing curing agent, and adhesion by applying pressure at ordinary temperature.

In the invention, the pad is a pile woven fabric or a spinning cloth in which loops are formed on its side of the adhesive film.

According to the invention, the adhesive agent in the adhesive layer is infiltrated and cured in the loops of the spinning cloth or the pile woven fabric. Therefore, the base fabric material and the pad member form stronger adhesion.

In the invention, the adhesive layer has a mesh-like shape and is joined in a state where ventilation property is ensured for each of gaps at predetermined intervals in the mesh-like shape.

According to the invention, an adhesion part and a non-adhesion part coexist also in the adhesion portion, and the original property of the member such as ventilation property, water-absorbing property, elasticity, and sweating property is maintained in the non-adhesion part.

### Advantageous Effects of Invention

According to the base fabric material having a pad member with a core of the invention, when it is applied to, for example, a supporter such as a knee pad, an elbow pad, and a waist pad, the core such as a cushion material sufficiently projects on an outer surface. Therefore, it possible to fully exert its elasticity to improve protection of knee, elbow, waist, etc.

According to the manufacturing method of the pad member with the core, by using a concave mold in adhering process, not only the core such as the cushion material sufficiently projects in an outer surface, but also it becomes easy to keep the shape of the cushion material or a thermal insulating material and keep the accuracy of attachment position thereof. Therefore, it becomes possible to quickly manufacture the base fabric material having the pad member with the core such as a supporter with strong adhesion that is beautifully finished more than conventional one.

### BRIEF DESCRIPTION OF DRAWINGS

FIG. 1 is a perspective view of a supporter of the invention.

FIG. 2 is a perspective view illustrating members used in the above supporter.

FIG. 3 is a cross-sectional view of the above supporter.

FIG. 4 is a perspective view of molds used in a manufacturing process of the invention.

FIG. 5 is a manufacturing process diagram of a first embodiment of the invention.

FIG. 6 is a manufacturing process diagram of a second embodiment of the invention.

FIG. 7 is a manufacturing process diagram of a third embodiment of the invention.

FIG. 8 is a manufacturing process diagram of a fourth embodiment of the invention.

FIG. 9 is a schematic view of a fifth embodiment of the invention.

FIG. 10 is a schematic view of a sixth embodiment of the invention.

FIG. 11 is images for comparison between the supporter of the invention and a supporter of a conventional manufacturing method.

FIG. 12 is a perspective view illustrating a pillowcase (in a state where a pillow is inserted) of the invention.

FIG. 13 is a perspective view illustrating the pillowcase (in a state where a pillow is not inserted) of the invention.

FIG. 14 is a schematic view illustrating a sock of the invention.

FIG. 15 is a schematic view illustrating a waist pad supporter of the invention.

FIG. 16 is a schematic view illustrating convex hot plates used in a manufacturing process in another embodiment of the invention.

FIG. 17 is a schematic view illustrating a method of using of a convex hot plate used in the manufacturing process in the other embodiment of the invention.

### DESCRIPTION OF EMBODIMENTS

Hereinafter, specific embodiments to which the invention is applied will be described in detail with reference to the drawings.

### First Embodiment

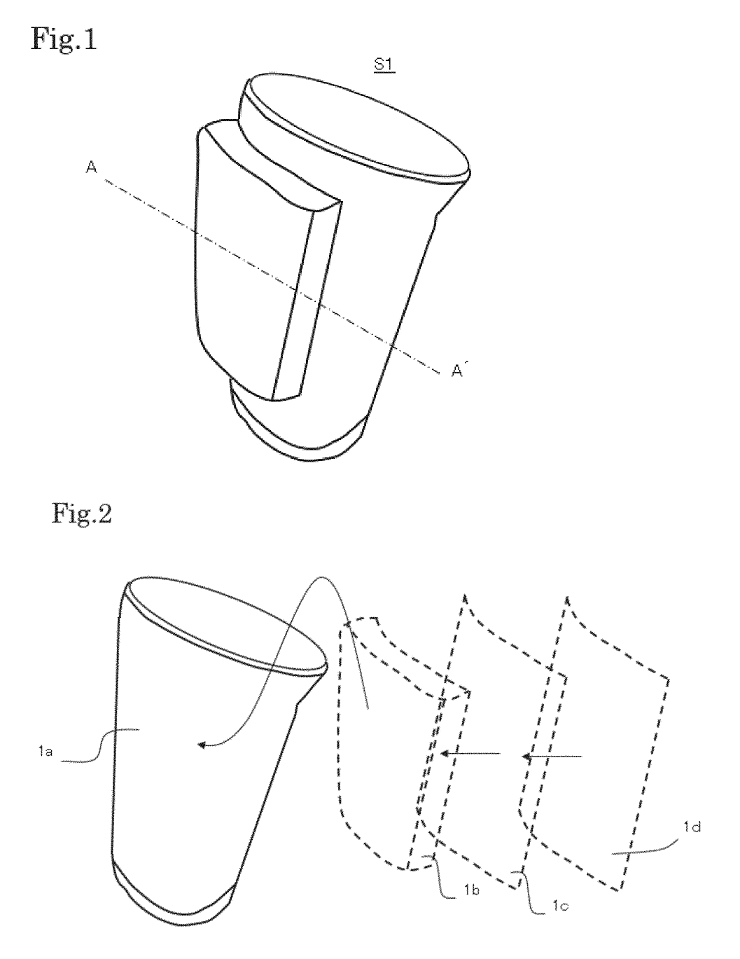

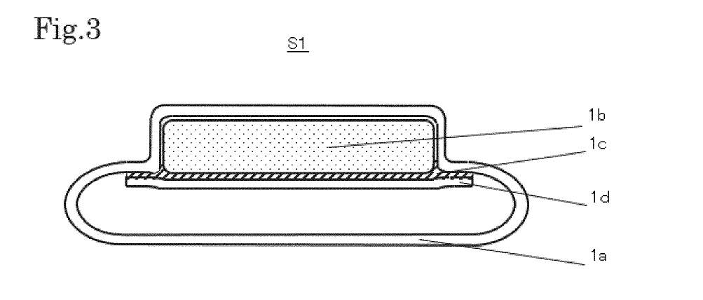

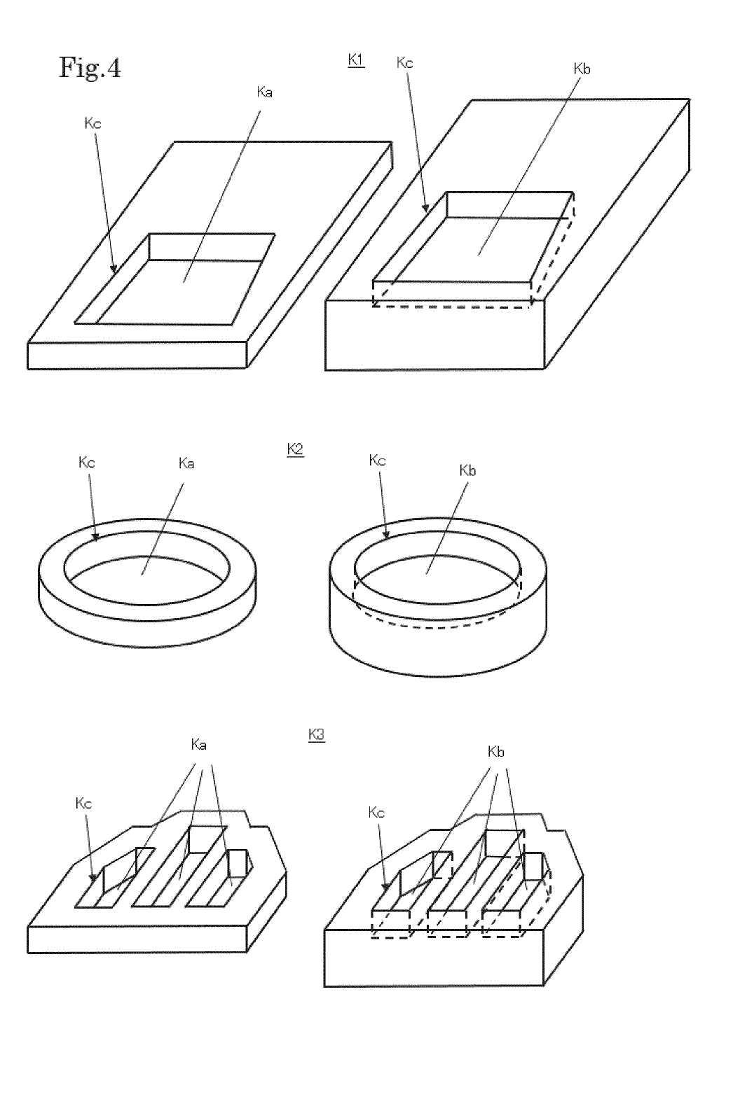

FIG. 1 is a perspective view illustrating a supporter S1 of a first embodiment of the invention, and FIG. 2 is a perspective view illustrating members to be used. FIG. 3 is an A-A cross-sectional view of the supporter S1.

The supporter S1 of the embodiment is described, assuming a case where the supporter S1 is configured as a cylindrical supporter with a cushion material which is used by being worn to protect elbow joint or knee joint of an athlete (volleyball or basketball player) from impact.

The supporter S1 is consisted of: a base fabric material 1a composed of a supporter body; a core 1b composed of a cushion material; a pad member 1d composed of a cloth having a size and a shape to just cover the cushion material; and an adhesive film 1c having the same size and the shape as those of the pad member 1d, and is manufactured by sandwiching the core 1b at a set position of the base fabric material 1a by the pad member 1d.

Although the base fabric material 1a is formed in a cylindrical shape (annular cross-section) in the example (FIG. 2), it may have an elongated shape or a rectangular shape in which its ends are not joined depending on the shape of the supporter.

As the material of the supporter, although a rubber fiber is inwoven in a fiber such as a rayon, a polyester, a nylon, and an acrylic, or pile processing is performed on the fiber , or the fiber is made to have a multi-layer structure, a chemical fiber such as rayon, polyester, and acrylic, and a member in which a rubbery chemical fiber is inwoven, a member subjected to a pile processing, or the like as an intermediate layer can be also used.

As a material of the cushion material, a urethane resin, a rubber, a foamed urethane resin, a foamed rubber, etc. are used.

As the adhesive film, a polyurethane-based thermal adhesive film is used from the standpoint of suitability with elasticity of the supporter. As the adhesive film, both films having a peelable sheet and no peelable sheet are available, and as for the film having the peelable sheet, a temporal adhesion process is preliminarily needed, but as for the film having no peelable sheet, no temporal adhesion process is needed.

The size of the pad member 1d and the adhesive film 1c is made to the size and the shape to just cover the core. However, by forming the size of the pad member 1d and the adhesive film 1c larger than the adhesive area of the core, it is possible to adhere strongly between the one side entire surface of the core and the pad member, and between the base fabric material located at a one side outer circumference of the core and the pad member.

The adhesive area between the base fabric material located at the one side outer circumference of the core and the pad member becomes larger as the size of the pad member 1d and the adhesive film 1c becomes larger than the adhesive area of the core. Therefore, it possible to form stronger adhesion, but the size is adequately selectable in consideration of adhesion method, cost, or the like.

In the example, the heat adhesive film 1c is used, but it is also possible to apply an adhesive agent to the pad member 1d for adhesion, and to use not only an adhesive agent having heat adhesive property that achieves adhesion by heating, but also various types of adhesive films and adhesive agents such as ultraviolet adhesive type that achieves adhesion within a short period by being irradiated by ultraviolet, curing agent mixed type that achieves adhesion by mixing the agent and a curing agent, and pressure sensitive type that forms adhesion by applying pressure under ordinary temperature.

As the pad member, a polyester, an arbitrary material such as a cloth made of a fabric such as cotton, or non-woven cloth may be used, but a knit material is suitable because of suitability with elasticity of the supporter.

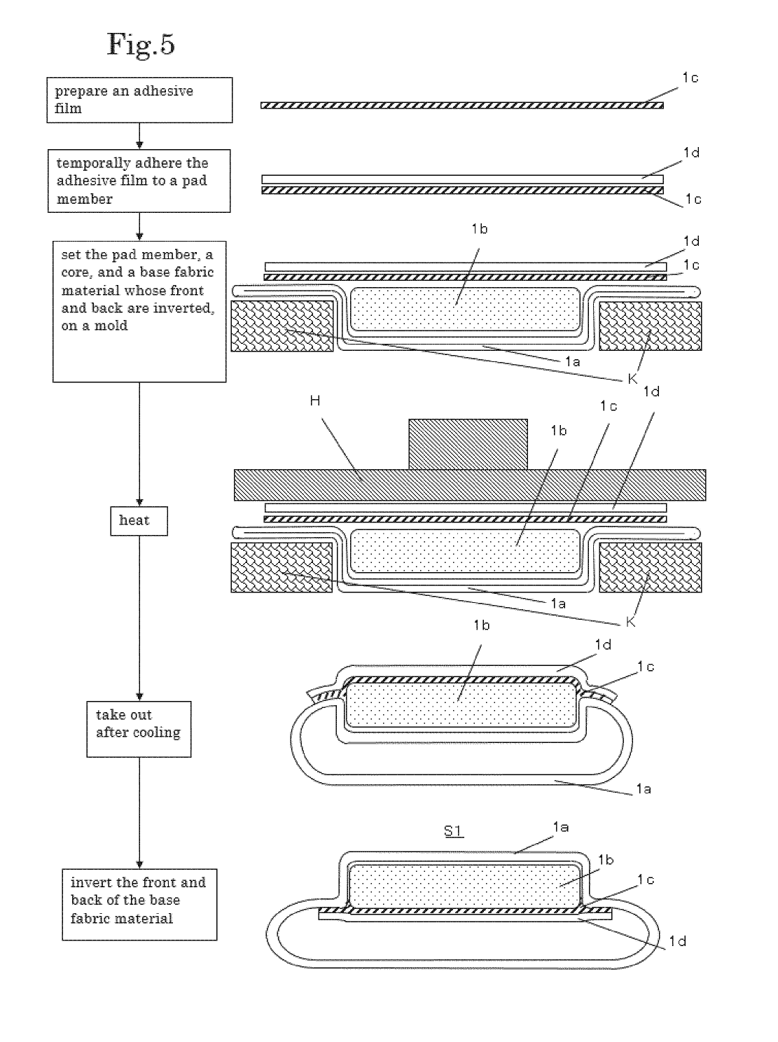

The first embodiment of the invention is performed by the manufacturing process of FIG. 5. The adhesive film 1c having the size and the shape equivalent to those of the pad member 1d is prepared, and is temporally adhered to the pad member 1d. The base fabric 1a whose front and back are inverted, the core 1b, and the pad member 1d to which the adhesive film 1c is temporarily adhered are set on a concave mold K (FIG. 4) having a hole or a groove made to match the shape and the thickness of the core 1b, and the adhesive film 1c is melted by heating by a hot plate H from the side of the pad member 1d to form adhesion between the base fabric material 1a and the pad member 1d. After cooling, the supporter S1 is completed by being taken out from the mold K and inverting the front and back of the base fabric material 1a.

Herein, the base fabric material 1a whose front and back are inverted, the core 1b, and the pad member 1d to which the adhesive film 1c is temporarily adhered are set on the concave mold K and heating is performed by the hot plate H from the side of the pad member 1d. However, the adhesion between the base fabric material 1a and the pad member 1d may be formed by inserting the concave mold K into the base fabric material 1a whose front and back are inverted, setting the core 1b and the pad member 1d to which the adhesive film 1c is temporally adhered on the base fabric material 1a, melting the adhesive film 1c by heating by the hot plate H from the side of the pad member 1d, and making the core 1b project inside the hole or the groove of the mold K.

Strong adhesion is formed between the base fabric material 1a and the pad member 1d. Although adhesion is formed also between the core 1b and the pad member 1d, the adhesion is not so strong due to the cushioning property of the core 1b and the affinity with the adhesive agent.

In the embodiment, the example is illustrated in which the size of the adhesive film 1c and the pad member 1d is equivalent, and the adhesion is formed on the entire surface of the pad member 1d. However, the adhesion formation range is not limited thereto, and is arbitrary within the range of the pad member. For example, the adhesion may be formed only at a circumference of the pad member 1d. In doing so, it is sufficient that a film in the range in which formation of adhesion is not desired is preliminarily removed by means such as die cutting or cutting at the stage of preparation.

Furthermore, it is also possible to form an adhesive layer on the area of the base fabric material 1a on which the core 1b contacts, and on the pad member 1d, so that the adhesive layer is formed on the entire outer circumference surface of the core 1b. It becomes possible to more strongly fix the core 1b to the base fabric material 1a by the formation of the adhesive layer on the entire outer circumference surface of the core 1b.

In the embodiment, the shape of the core of the supporter S1 is rectangular, and the manufacturing process in which the mold K1 having the size and the thickness made to match the rectangular shape is used is exemplified. However, the shape of the core is optional, and when the core 1b has a circular shape, a mold K2 having a circular shape made to match the shape is used (FIG. 4). Alternatively, a plurality of separated cores 1b may be used, and in this case, a mold K3 (FIG. 4) having a plurality of separated parts is used. The thicknesses of a hole (hollow shape) Ka of the mold K and the core 1b are same. Although a concave groove Kb may be formed in the mold K, a projecting amount of the core 1b to the outer side can be made larger in the above hollow shape Ka. An underlay (underlay made of a cloth) or an iron plate may be laid below the mold to increase sticking force.

In the embodiment, the base fabric material 1a and the pad member 1d are adhered by thermocompression bonding. In the invention, however, they may be adhered to each other by heating the adhesion portion by means of laser heating, high-frequency heating, hot plate heating, vibration heating, ultrasonic heating, or heating performed by spraying thermal gas such as steam. Furthermore, any adhesion method may be employed as long as adequate adhesion can be achieved such as a short-time adhesion method by irradiating ultraviolet, an adhesion method by mixing the agent and a curing agent, and an adhesion method by applying pressure at ordinary temperature.

### Second Embodiment

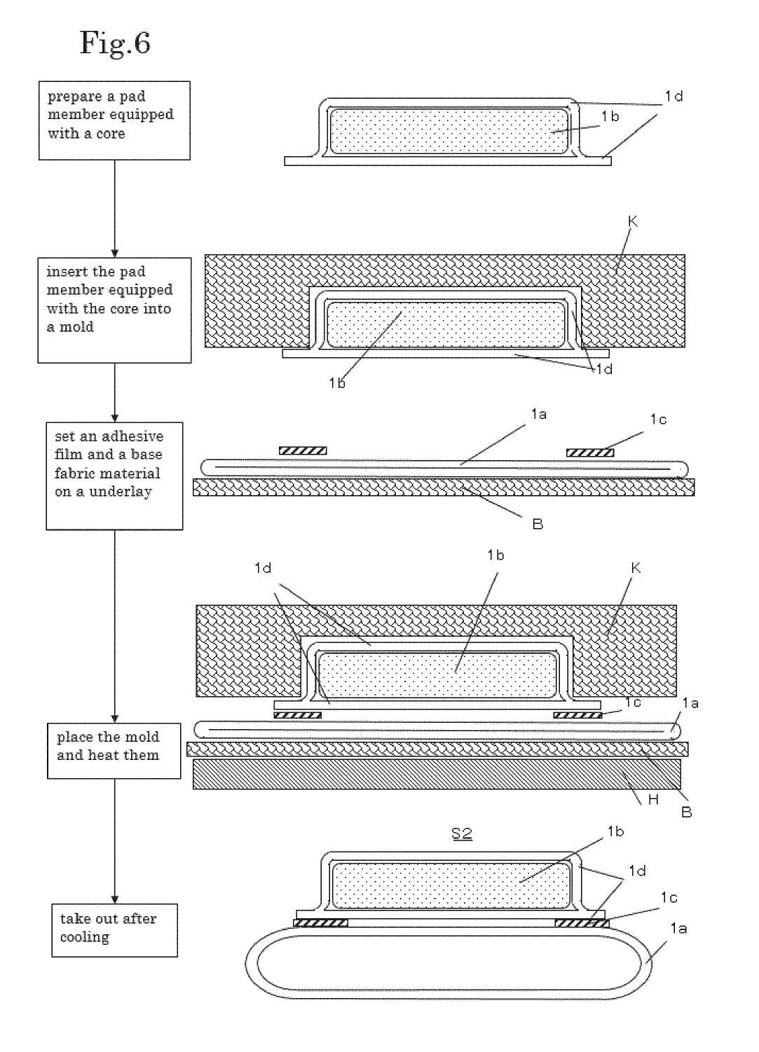

The second embodiment of the invention is performed by the manufacturing process of FIG. 6.

A pad 1d preliminarily equipped with a core 1b is prepared, and the pad member 1d preliminarily equipped with the core 1b is inserted into a concave mold K4 (Fig. 4) having a hole or a groove made to match the shape and the thickness of the core 1b. A base fabric 1a and an adhesive film 1c corresponding to an adhering region are set on an underlay, the mold K into which the above pad member 1d and the core 1b are fitted is placed from thereabove, the adhesive film 1c is melted by heating by a hot plate H from the side of the underlay to form adhesion between the base fabric material 1a and the pad member 1d. After cooling, a supporter S2 is completed by being taken out from the mold K.

In the embodiment, as the pad member 1d preliminarily equipped with the core 1b, the example is illustrated in which a core is inserted in the intermediate layer of the pad member. However, it is sufficient that a core is preliminarily held by a pad member like the one in which a core is hold by a cylindrical pad member, or the like, and the configuration is not limited to the configuration of the embodiment.

In the embodiment, the mold K having the groove is mounted on the underlay from upper direction so as to perform the heat adhering process, but this is not limited thereto. As for the mold structure, the mold K having a hole may be used, and the mold K may be set in the lower side and place the adhesive film 1c and the base fabric material 1a thereon to heat from the upper side.

### Third Embodiment

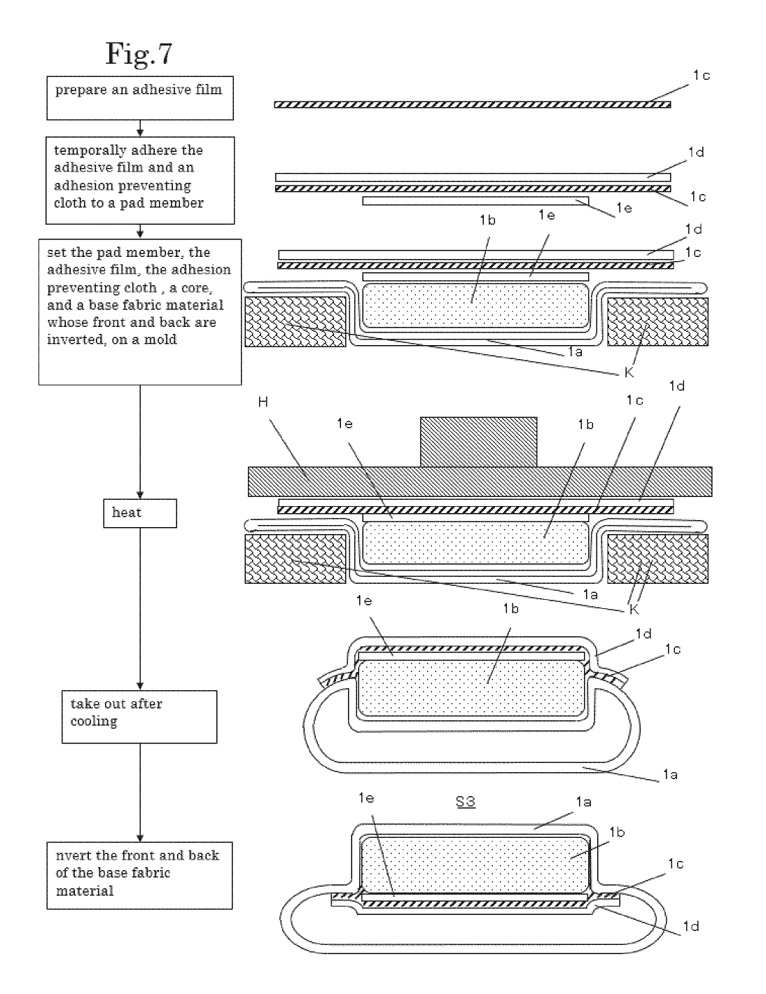

The third embodiment of the invention is performed by the manufacturing process of FIG. 7.

An adhesive film 1c having a size and a shape equivalent to those of a pad member 1d and an adhesion preventing cloth 1e are prepared, and are temporally adhered to the pad member 1d. Herein, the adhesion preventing cloth is the cloth that is pasted at a preliminarily set non-adhered section. For example, in the case where the portion of the core 1b is not adhered, a cloth made to match the outer shape of core 1b is temporally adhered on the adhesive film 1c. The position where the adhesion preventing cloth 1e is adhered is not fixed to the core portion, and can be adhered at a free position on the adhesive film depending on a design intention and can also be adhered at a plurality of positions.

The base fabric 1a whose front and back are inverted, the core 1b, and the pad member 1d to which the adhesive film 1c and the adhesion preventing cloth 1e are temporarily adhered are set on the mold K (FIG. 4) made to match the shape and the thickness of the core 1b, and the adhesive film 1c is melted by heating by the hot plate H from the side of pad member 1d to form adhesion between the base fabric material 1a and the pad member 1d. After cooling, supporter S3 is completed by being taken out from the mold K and inverting the front and back of the base fabric material 1a.

In the embodiment, the method forms strong adhesion between the base fabric material 1a and the pad member 1d, while a portion between the core 1b and the pad member 1d is not adhered by means of the adhesion preventing cloth 1e. For example, since it is not preferable to apply an adhesive agent at the section where ensuring of ventilation property is desired, it is preferable to dispose the adhesion preventing cloth 1e at the section where ventilation property is ensured.

### Fourth Embodiment

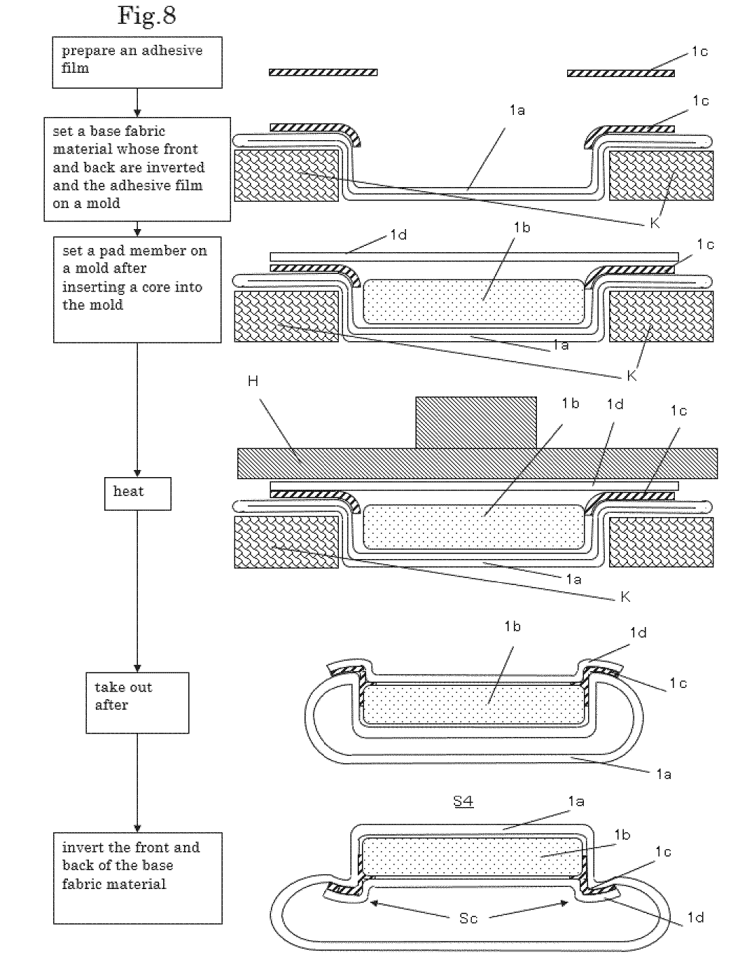

The fourth embodiment of the invention is performed by the manufacturing process of FIG. 8.

An adhesive film 1c is prepared such that its inner circumference is made smaller than the mold inner circumference to the level to be weighted down on the side face of an inside corner Kc (FIG. 4) of a mold K (FIG. 4) made to match the shape and the thickness of a core 1b and its outer circumference becomes equivalent to that of a pad member 1d. The base fabric 1a whose front and back are inverted and the above adhesive film 1c are set on the mold K (FIG. 4), the core 1b is then inserted in the mold, the pad member 1d is set, and the adhesive film 1c is melted by heating by a hot plate H from the side of the pad member 1d to form adhesion between the base fabric material 1a and the pad member 1d. After cooling, a supporter S4 is completed by being taken out from the mold and inversing the front and back of the base fabric material 1a.

Strong adhesion is formed between the base fabric material 1a and the pad member 1d. Furthermore, by the adhesive film set at the position of the side face of the above mold, adhesion is formed between the base fabric material 1a and a lower corner of the core 1b, and the pad member 1d and a side face portion of the core 1d.

By the formation of the above adhesion, a fold Sc may be generated in the base fabric material 1a and the pad member 1d near the lower corner of the core 1b of the supporter S3 (FIG. 7). Thereby, the core 1b in the supporter S4 manufactured in the fourth embodiment remarkably projects on the surface side as compared with that of the supporters S1 and S3 respectively manufactured in the first and third embodiments, and its shape keeping ability is improved, making it possible to prevent shapeless of the core 1b and the pad member 1d.

### Fifth Embodiment

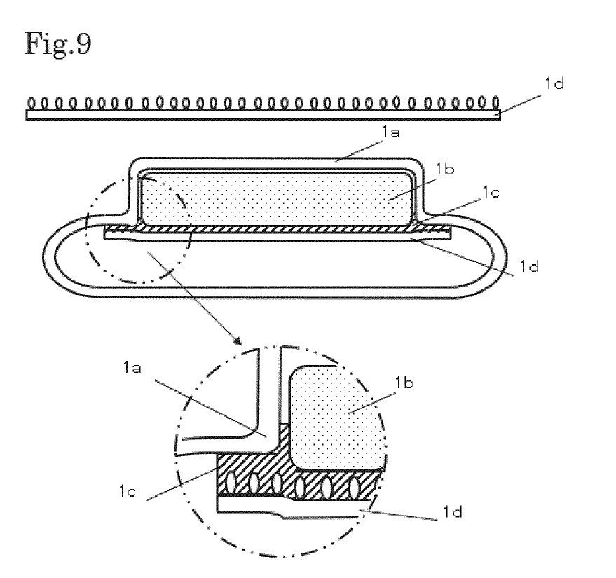

The fifth embodiment of the invention is schematically illustrated in FIG. 9.

FIG. 9 schematically illustrates a microstructure of the adhesion portion of the supporter S1 manufactured in the above first embodiment when the pad member 1d is a pile woven fabric or a spinning cloth in which loops are formed on the side of the adhesive film. The adhesive agent of the adhesive film 1c is infiltrated and cured in the loops of the pad member 1d to achieve strong adhesion. Thereby, the strength equivalent to or not less than that provided by the conventional sewing, and thus, peeling off does not occur by the force that is applied during strenuous exercise by a supporter wearer.

### Sixth Embodiment

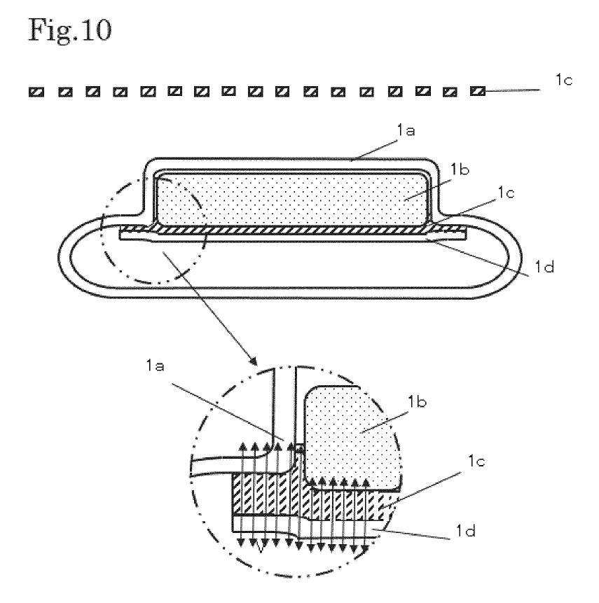

The sixth embodiment of the invention is schematically illustrated in FIG. 10.

FIG. 10 schematically illustrates a microstructure of the adhesion portion of the supporter S1 manufactured in the above first embodiment when the adhesive film 1c has a mesh-like shape. In the adhesion portion, gaps are formed according to a predetermined interval in the mesh to ensure ventilation routes V. This enables to ensure ventilation property, water-absorbing property, elasticity, and sweating property, which are original property of the member.

According to the invention, it becomes possible to design adhesion depending on a design intention, for example, a sheet-like adhesive film is used in the area in which adhesive strength is prioritized, while a mesh-like adhesive film is used in the area in which original property of the member are prioritized, exerting superiority of increase in the degree of freedom in product designing of the supporter or the like.

### Comparison between the Supporter of the Invention and the Supporter by Conventional Manufacturing Method

FIG. 10 shows images of a supporter according to the invention and a supporter by a conventional manufacturing method. S1 is a supporter manufactured by the above first embodiment, and So is a supporter manufactured by sewing a supporter body and a pad member, which is a conventional manufacturing method. The supporter S1 of the invention is remarkable in projection of the cushion material on the surface side as compared with conventional supporter So, and it is apparent that its elasticity can be sufficiently exerted, and improvement of performance of protecting knee, elbow, waist, or the like can be expected. Therefore, it is apparent that the effect of the invention largely contributes to improvement of the performance of the supporter or the like with the cushion material.

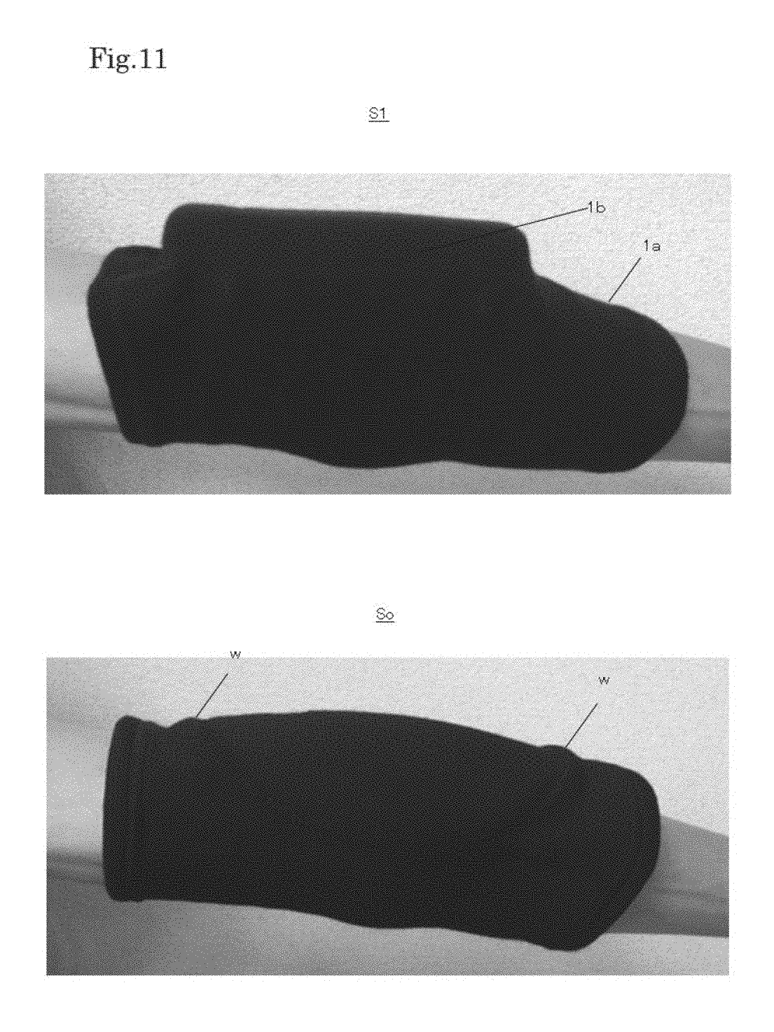

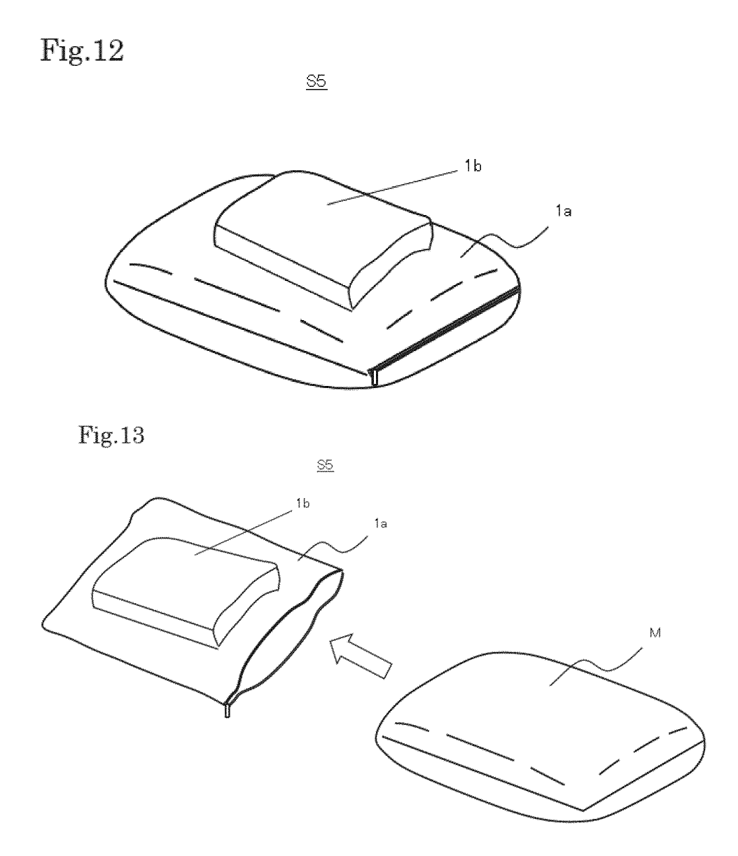

Furthermore, in the supporter S1 of the invention, since no needless stress is applied to the joint between the supporter body and the pad member, the joint is flat, but in the conventional supporter So, a stress due to sewing remains, resulting in appearance of the shape that does not contribute to the original functions of the supporter such as wrinkles and creases (“w” in FIG. 11) around the sewing portion. Therefore, it is apparent that the invention also makes it possible to manufacture a supporter finished more beautifully in appearance.

### Seventh Embodiment

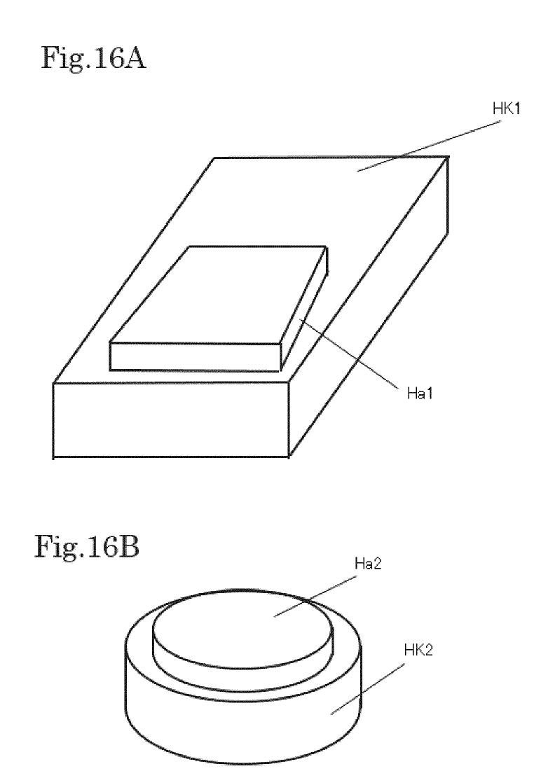

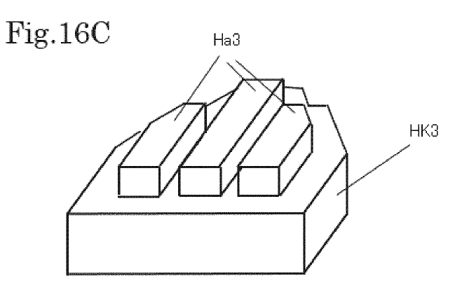

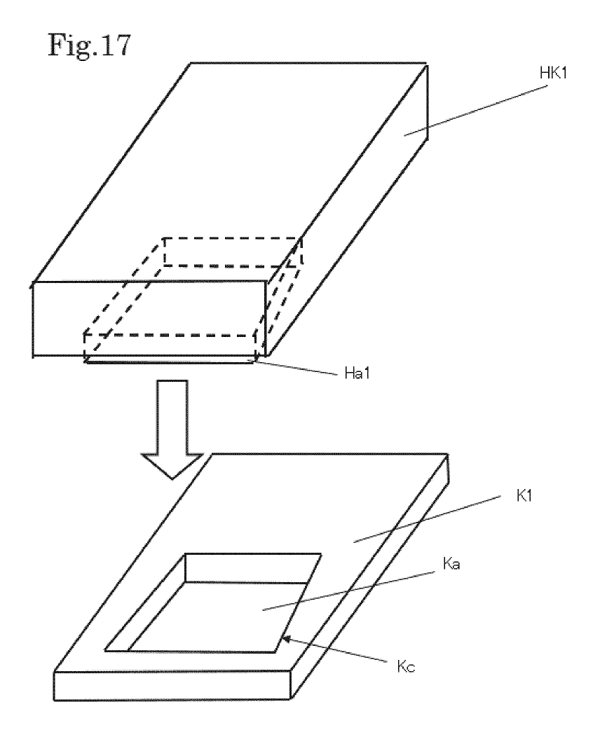

FIG. 16 is a schematic view illustrating convex hot plates used in a manufacturing process in the other embodiment of the invention, and FIG. 17 is a schematic view illustrating a using method of a convex hot plate used in the manufacturing process in the other embodiment of the invention.

In the first, second, third, fourth fifth, or sixth embodiments, the supporters S1, S2, S3, or S4 are formed by setting the base fabric material 1a whose front and back are inverted, the core 1b, and the pad member 1d to which the adhesive film 1c is temporarily adhered on the concave mold K, K1, K2, or K3, and then heating the hot plate H from the side of the pad member 1d. However, in a seventh embodiment, it is possible to provide a base fabric material having a pad member with a core in which the core is made to project on the further outside and quickly and strongly joined in a beautiful finished state, and a manufacturing method thereof by using the convex hot plates HK1, HK2, HK3 equipped with a convex portion.

The convex hot plates HK1, HK2, HK3 are hot plates used in a state of facing the concave mold K when the supporter is manufactured, and respectively includes convex portions Ha1, Ha2, Ha3.

Although the convex portions Ha1, Ha2, Ha3 have a same sectional shape as a hole Ka or a groove Kb provided in the concave mold K to be used, the sizes thereof are made smaller than the hole Ka or the groove Kb, and the heights of the convex portions Ha1, Ha2, Ha3 are made shorter than the depth of the hole Ka or the groove Kb provided in the concave mold K.

The base fabric 1a whose front and back are inverted, the core 1b, and the pad member 1d to which the adhesive film 1c is temporarily adhered are set on the concave mold K having the hole or the groove made to match the shape and the thickness of the core 1b, and the convex portions Ha1, Ha2, Ha3 are pressed against the core 1b so that the core 1b sufficiently projects on the base fabric material surface side while the adhesive film 1c is melted by heating by the convex hot plates HK1, HK2, HK3 from the side of the pad member 1d. Since the section other than the convex portions Ha1, Ha2, Ha3 of the convex hot plates HK1, HK2, HK3 is also at high temperature, the adhesive film 1c between the base fabric material 1a and the pad member 1d located at an outer circumference of the adhesive surface of the core 1b is also melted by the convex hot plates HK1, HK2, HK3, and strong adhesion is simultaneously formed.

In this manner, by pressing the convex portions Ha1, Ha2, Ha3 against the core 1b so that the core 1b sufficiently projects on the base fabric material surface side while melting the adhesive film 1c from the side of pad member 1d by using convex hot plates HK1, HK2, HK3 respectively equipped with concave portions Ha1, Ha2, Ha3, it is possible to provide a beautifully finished base fabric material having a pad member with a core in which the core further projects on the outer side.

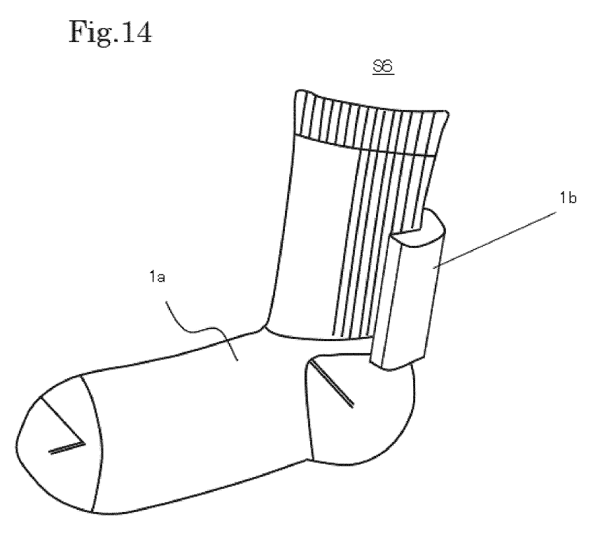

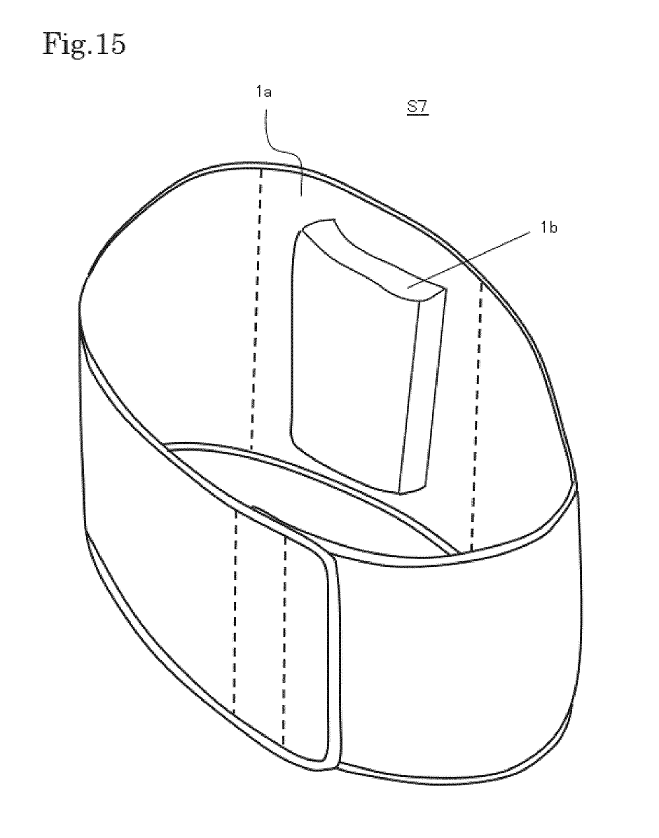

FIG. 12 is a perspective view illustrating a pillowcase (in a state where a pillow is inserted state)) of the invention, and FIG. 13 is a perspective view illustrating a pillowcase (in a state where a pillow is not inserted) of the invention. FIG. 14 is a schematic view illustrating a sock of the invention, and FIG. 15 is a schematic view illustrating a waist pad supporter of the invention. In the first, second third, fourth, fifth, and sixth embodiments, description is made with respect to the supporters S1, S2, S3, S4, but the invention is not limited to the supporters and is applicable to various members used by joining a core composed of a cushion material to a base fabric material, specifically, to the members such as a pillowcase (FIG. 12, FIG. 13), a sock (FIG. 14), and a waist pad supporter (FIG. 15). In this manner, in the invention, it goes without saying that appropriate alterations are possible without departing from the scope of the gist.

### REFERENCE NUMERALS

S1, S2, S3, S4 supporter of the invention
S5 pillow of the invention
S6 sock of the invention
S7 waist pad supporter of the invention
1a base fabric material constituting the supporter
1b core constituting the supporter
1c adhesive film constituting the supporter
1d pad member constituting the supporter
1e adhesion preventing cloth
Sc fold in the supporter
K mold of the invention
K1 mold for rectangular core
K2 mold for circular core
K3 mold for a plurality of cores
Ka hole of mold (hollow shape)
Kb groove of mold (concave)
Kc corner of mold
H hot plate
HK1 convex hot plate for rectangular core
HK2 convex hot plate for circular core
HK3 convex hot plate for a plurality of cores
Ha1, Ha2, Ha3 convex portion
B underlay
V ventilation routes
So supporter of conventional manufacturing method
w crease of supporter
M pillow

1.-12. (canceled)

13. A base fabric material having a pad member with a core, comprising:
a base fabric material having elasticity and having an annular cross-section;
a core disposed to project from an outer face of the base fabric material in its entire area by being adhered to the base fabric material from an inner face of the base fabric material;
a pad member disposed on the inner face of the base fabric material to cover the core; and
an adhesive layer for joining them.

14. The base fabric material having the pad member with the core according to claim 13, wherein
the base fabric material having the pad member with the core further comprises an adhesion preventing cloth disposed at a non-adhered section of the adhesive layer, and ventilation property is ensured at a position at which the adhesion preventing cloth is disposed.

15. The base fabric material having the pad member with the core according to claim 13, wherein the base fabric material having the pad member with the core is a knee supporter or an elbow supporter.

16. A manufacturing method of a base fabric material having a pad member with a core, comprising:
providing a base fabric material having elasticity and having an annular cross-section, a core such as a cushion material, a pad member disposed on the inner face of the base fabric material to cover the core, and an adhesive layer for joining them;
adhering it to the base fabric material from the inner side face (an outer face when the front and back are inverted) of the base fabric material so as to join the pad member having the core to a one side surface of the base fabric material with its substantially entire area of thickness projecting; and
inverting the front and back.

17. A manufacturing method of a base fabric material having a pad member with a core comprising:
inserting a mold having a hole or a groove made to match a shape and a thickness of a core inside a base fabric material having elasticity and having an annular cross-section whose front and back are inverted;
disposing the core and a pad member to which an adhesive layer is temporally adhered on an inner face (an outer face when the front and back are inverted) of the base fabric material;
melting the adhesive layer by heating by a hot plate from a side of the pad member;
making the core to project inside the hole or the groove of the mold so as to adhere the base fabric material and the pad member; and
inverting the front and back.

18. The manufacturing method of the base fabric material having the pad member with the core according to claim 16, wherein the base fabric material having the pad member with the core is a knee supporter or an elbow supporter.
